(19) United States
(12) Patent Application Publication
(10) Pub. No.: US 2022/0377356 A1
(43) Pub. Date: Nov. 24, 2022

(54) VIDEO ENCODING METHOD, VIDEO ENCODING APPARATUS AND COMPUTER PROGRAM

(71) Applicant: NIPPON TELEGRAPH AND TELEPHONE CORPORATION, Tokyo (JP)

(72) Inventors: Seishi TAKAMURA, Musashino-shi, Tokyo (JP); Hideaki KIMATA, Musashino-shi, Tokyo (JP)

(73) Assignee: NIPPON TELEGRAPH AND TELEPHONE CORPORATION, Tokyo (JP)

(21) Appl. No.: 17/773,987

(22) PCT Filed: Nov. 15, 2019
(86) PCT No.: PCT/JP2019/044904

§ 371 Date: May 3, 2022

(51) Int. Cl. H04N 19/23; H04N 19/105; H04N 19/61

(52) U.S. Cl. CPC H04N 19/23; H04N 19/105; H04N 19/61

(57) ABSTRACT

A video encoding method includes: a provisional image generation step of generating one provisional image from a plurality of frames to be coded; a transformation step of transforming the generated provisional image to a transformed image having the same number of pixels as that of each of the plurality of frames to be coded; and a prediction image generation step of generating a prediction image for each of the frames to be coded, using the transformed image as a reference image.

### TECHNICAL FIELD

The present invention relates to a technique for coding videos.

### BACKGROUND ART

In inter prediction, which is one of the prediction methods used when coding a video, a different frame from a frame to be coded is used as a reference image. In inter prediction, it is common to use, as a reference image, a past or future frame rather than the frame to be coded. However, a technology of generating and use, as a reference image, an image that is highly correlated with a plurality of frames to be coded, instead of a past or future frame, has been proposed. A sprite mode, such as that disclosed in NPL 1, is one example of such a technique.

An example of using the sprite mode will be described. A sprite image is generated using images with a common background in the environment in which a plurality of frames to be coded are captured. The sprite image is used as a reference image, and an image of a foreground portion that is not included in the sprite image is coded using an object coding technique. A reduction in bit size used in the reference image is realized such this processing, and as a result, highly efficient compression is enabled.

### CITATION LIST

### Non Patent Literature

[NPL 1] “Versatile Video Coding (Draft 6)”, Joint Video Experts Team (JVET) of ITU-T SG 16 WP 3 and ISO/IEC JTC 1/SC 29/WG 11, 15th Meeting Gothenburg, SE, 3-12 Jul. 2019

### SUMMARY OF THE INVENTION

### Technical Problem

The sprite image needs to have a larger number of pixels than a frame to be coded. This is because a plurality of frames, such as frames captured with the viewpoint moved and frames captured with the zoom changed, serve as frames to be coded, and the background image of the plurality of frames to be coded is included in the sprite image. For this reason, there is a problem in that the sprite image cannot be effectively used with a coding technique that has a restriction that requires each frame to be coded and the reference image to have the same number of pixels, for example. VVC (versatile video coding) is a specific example of a coding technique with such a restriction. With a coding technique such as VVC, there are cases prediction is made while assuming different backgrounds for the respective frames to be coded. That is to say, even in a group of frames that capture at least partially different regions in the same space, these regions being in the same space is not considered, and only the correlation between the frames can be used. In other words, although the correlation between frames for which inter prediction is to be performed can be used, the correlation between the same space and the background of the frames cannot be used. Thus, there are case where the background that is common to a plurality of frames to be coded, i.e., the correlation between reference images cannot be used, resulting in a decrease in coding efficiency.

In view of the foregoing circumstances, an object of the present invention is to provide a technique capable of improving coding efficiency in a coding technique in which the number of pixels of a reference image is required to be the same as the number of pixels of a frame to be coded.

### Means for Solving the Problem

An aspect of the present invention is a video encoding method including: a provisional image generation step of generating one provisional image from a plurality of frames to be coded; a transformation step of transforming the generated provisional image to a transformed image having the same number of pixels as that of each of the plurality of frames to be coded; and a prediction image generation step of generating a prediction image for each of the frames to be coded, using the transformed image as a reference image.

An aspect of the present invention is a video coding device including: a provisional image generation unit for generating one provisional image from a plurality of frames to be coded; a transformation unit for transforming the generated provisional image to a transformed image having the same number of pixels as that of each of the plurality of frames to be coded; and a prediction image generation unit for generating a prediction image for each of the frames to be coded, using the transformed image as a reference image.

An aspect of the present invention is a computer program for causing a computer to execute the above-described video coding method.

### Effects of the Invention

According to the present invention, coding efficiency can be improved in a coding technique in which the number of pixels of a reference image is required to be the same as the number of pixels of an image to be coded.

### BRIEF DESCRIPTION OF DRAWINGS

FIG. 1 is a schematic block diagram showing an outline of a functional configuration of a coding device 100.

FIG. 2 is a flowchart showing a specific example of a processing flow of the coding device 100.

FIG. 3 is a diagram showing an outline of a hardware configuration of the coding device 100.

FIG. 4 is a diagram showing the result of conducting a performance comparison experiment between the coding device 100 of the present embodiment and a conventional coding device.

FIG. 5 is a diagram showing the result of conducting a performance comparison experiment between the coding device 100 of the present embodiment and a conventional coding device.

FIG. 6 is a diagram showing the result of conducting a performance comparison experiment between the coding device 100 of the present embodiment and a conventional coding device.

### DESCRIPTION OF EMBODIMENTS

An embodiment of the coding method of the present invention will be described in detail with reference to the drawings.

### [Summary]

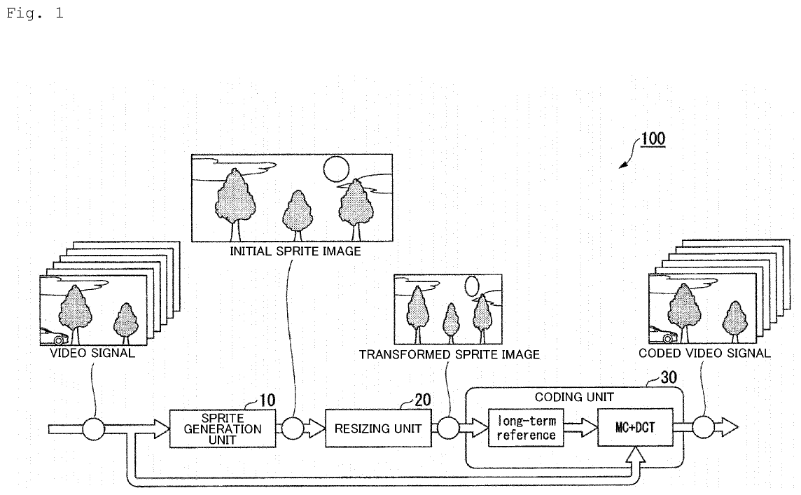

FIG. 1 is a schematic block diagram showing an outline of a functional configuration of a coding device 100 (video coding device). The coding device 100 is constituted by, for example, an information processing apparatus, such as a personal computer or a server device. For example, VVC (Versatile Video Coding) may be mounted on the coding device 100 shown in FIG. 1. The coding device 100 of the present invention includes a sprite generation unit 10 (provisional image generating unit), a resizing unit 20 (transformation unit), and a coding unit 30 (prediction image generation unit). The sprite generation unit 10 generates an initial sprite image (provisional image) based on an input video signal. A conventional technique for generating a sprite image may be applied to the sprite generation unit 10. The size (the number of pixels) of the initial sprite image generated by the sprite generation unit 10 is larger than that of a frame to be coded included in the video signal. The initial sprite image is captured while being divided by a plurality of frames, and is assumed as a background or the like obtained by removing or reducing foreground components of each frame.

The resizing unit 20 generates a transformed sprite image by performing image processing on the initial sprite image. This is because VVC implements image processing (affine transformation), which was not supported up to HEVC, and thus the created initial sprite image can be transformed to a transformed sprite image of a desired size. The size of the transformed sprite image is smaller than the initial sprite image. The size of the transformed sprite image is, for example, the same as the size of each frame to be coded included in the video signal. The coding unit 30 applies the transformed sprite image as a long-term reference frame, and codes each frame to be coded included in the video signal.

Thus, the coding device 100 generates the initial sprite image that is larger than each frame to be coded, and transforms the initial sprite image so as to have the same size as the frame to be coded. As a result, coding efficiency can be improved in a coding technique in which the number of pixels of a reference image is required to be the same as the number of pixels of an image to be coded. The details of the coding device 100 will be described below.

### [Details]

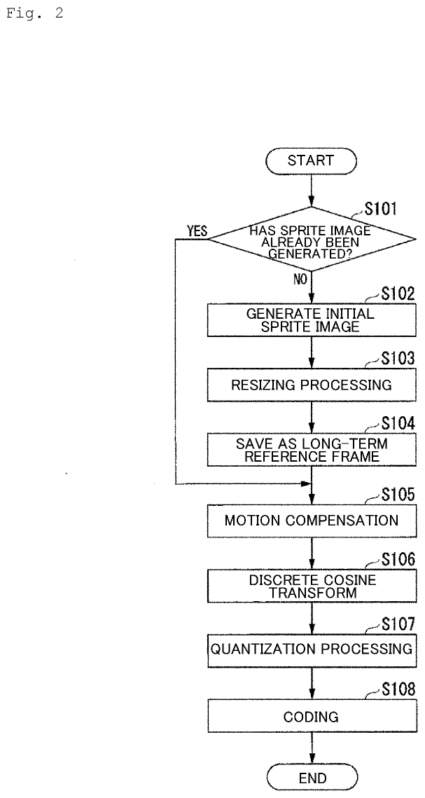

FIG. 2 is a flowchart showing a specific example of a processing flow of the coding device 100. In the coding device 100, first, the sprite image is generated (step S101—NO). Specifically, the sprite generation unit 10 generates the initial sprite image based on the input video signal (a plurality of frames to be coded) (step S102). The technique used when the sprite generation unit 10 generates the initial sprite image may be a conventional technique for generating a sprite image. The size (the number of pixels) of the initial sprite image generated by the sprite generation unit 10 is larger than that of each frame to be coded included in the video signal.

Next, the resizing unit 20 generates the transformed sprite image by performing image processing including resizing processing on the initial sprite image (step S103). The size of the transformed sprite image is smaller than the initial sprite image. The size of the transformed sprite image is, for example, the same as the size of each frame to be coded included in the video signal. If all frames to be coded included in the video signal have the same size, these frames to be coded and the transformed sprite image all have the same size.

It is desirable that the transformed sprite image includes an image of an entire region included in the initial sprite image. It is therefore desirable that image reduction processing is used to generate the transformed sprite image. Further, rotation processing and/or shearing processing may also be used to generate the transformed sprite image. In this case, to generate the transformed sprite image, a combination of a reduced image and rotation processing may be used, or a combination of a reduced image and shearing processing may be used, or a combination of a reduced image, rotation processing, and shearing processing may be used. For such image processing, for example, affine transformation may be applied.

The transformed sprite image generated by the resizing unit 20 is used as a long-term reference frame by the coding unit 30. For example, the transformed sprite image is saved as the long-term reference frame in a frame memory included in the coding unit 30 (step S104).

After the transformed sprite image has been saved as the long-term reference frame (step S101—YES), coding processing is performed for each of the frames to be coded included in the input video signal, using the long-term reference frame and a frame that has already been decoded and can be referenced. Existing coding processing may be applied for this coding processing. In the present embodiment, the VVC coding processing is applied as mentioned above. Specifically, the coding unit 30 performs motion compensation for the frames to be coded, using the long-term reference frame (step S105). The coding unit 30 generates a prediction image for each frame to be coded by performing motion compensation.

When generating the prediction image, the coding unit 30 may specify a reference region that corresponds to a region to be coded in the transformed sprite image and has a different number of pixels from the number of pixels of the region to be coded, using the relationship between the frames to be coded used when generating the initial sprite image. The coding unit 30 may perform transformation processing on the transformed sprite image in motion compensation. Transformation processing is processing for transforming an image, and is, for example, processing such as scaling processing, rotation processing, or shearing processing. Such transformation processing may be executed using affine transformation. Since such transformation processing is performed, it is possible to obtain substantially the same effects as those obtained when the sprite image is used as the long-term reference frame even if the transformed sprite image generated by reducing the initial sprite image is used as the long-term reference frame. That is, for example, even if the transformed sprite image is generated by reducing the initial sprite image, it is possible to obtain the same effects as those obtained when the initial sprite image is used as a reference image, by enlarging the transformed sprite image to the same size as the initial sprite image and then using the enlarged transformed sprite image as the reference image.

Thereafter, the coding unit 30 generates a prediction residual signal by subtracting the prediction signal obtained through motion compensation and the video signal of the frames to be coded. The coding unit 30 performs a discrete cosine transform on the prediction residual signal (step S106), and performs quantization processing (step S107). The coding unit 30 then generates coded data by performing coding processing on the quantized prediction residual signal (step S108).

FIG. 3 is a diagram showing an outline of a hardware configuration of the coding device 100. The coding device 100 has a processor 50, a memory 60, an I/O 70, and an auxiliary storage device 80 as hardware components. The processor 50 may function as the sprite generation unit 10, the resizing unit 20, and the coding unit 30 by executing a coding program stored in the memory 60. The memory 60 may function as a memory for holding the long-term reference frame. The I/O 70 may input the video signal and output the coded data. The auxiliary storage device 80 may store the video signal and store the coded data.

The coding program may be recorded in a computer-readable recording medium. The computer-readable recording medium refers to, for example, a portable medium such as a flexible disk, a magneto-optical disk, a ROM, or a CD-ROM, or a non-transitory storage medium including a storage device such as a hard disk built in a computer system. The coding program may be transmitted over a telecommunication line. Some or all of the operations of the sprite generation unit 10, the resizing unit 20, and the coding unit 30 may be, for example, realized by using hardware including an electronic circuit using an LSI, an ASIC, a PLD, or an FPGA.

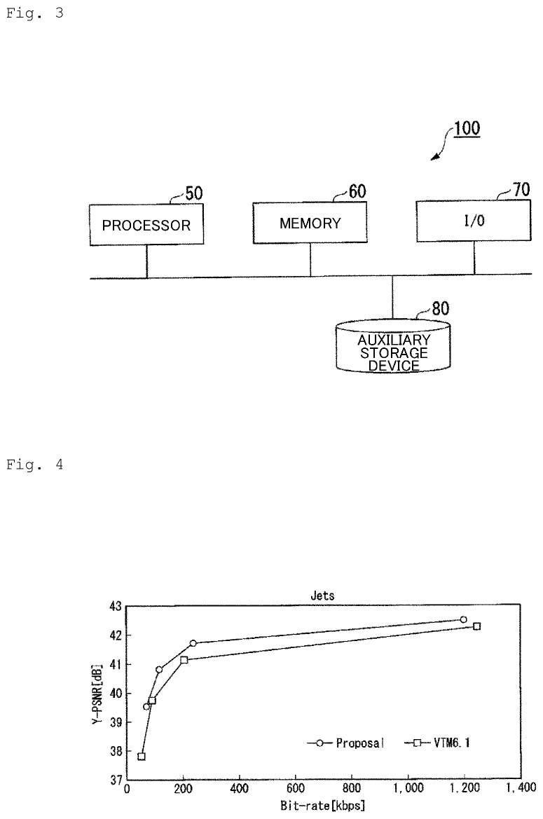

FIGS. 4 to 6 are diagrams showing the results of conducting performance comparison experiments between the coding device 100 of the present embodiment and a conventional coding device. Videos used in the experiments are a real video Jets (1280×720, 60 Hz, first 300 frames) including camera work and EBUKidsSoccer (8 bits, 4:2:0, 1920×1080, 500 frames, hereinafter Soccer). For the generation of the initial sprite image, the 300th frame for Jets and the 250th frame for the Soccer were used as key frames. Jets involves panning and zooming, and Soccer is dominated by panning. The initial sprite image was generated by applying a median filter in the time direction for a region covered by all frames. The transformed sprite image was generated by changing the horizontal and vertical magnification of the initial sprite image to the same size as the input frame size.

The coding conditions as follows. VVC reference software VTM6.1 was used as an encoder. The coding structure is Low Delay B, and the base quantization parameters (QP) are 22, 27, 32, and 37. In default coding settings, the use of affine motion compensation is on (Affine=1), but the settings were changed to AffineAmvr=1, AffineAmvrEncOpt=1 in the expectation that affine motion compensation is to be more actively used. Initially, sprites were coded as long-term reference frames with a QP 10 smaller than the base QP, and then the entire input sequence was coded. PSNR was evaluated without the sprites, and the code volume was evaluated with the sprite.

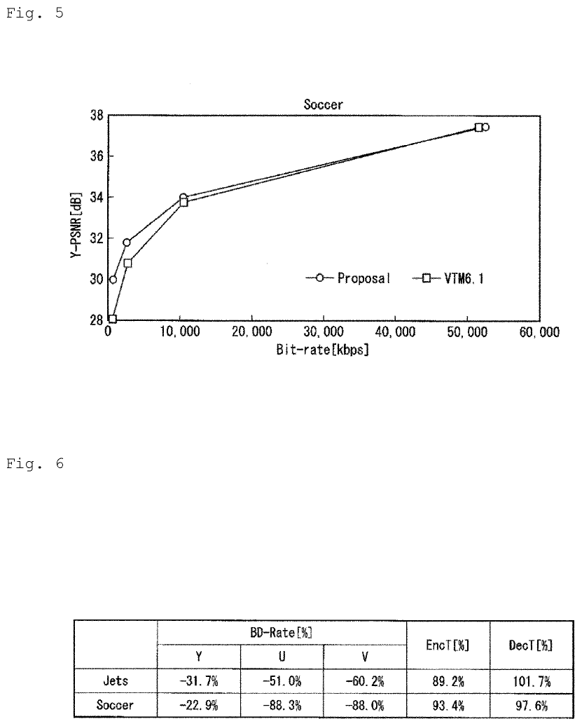

FIGS. 4 and 5 show R-D curves obtained as a result of the experiments. Although a slight deterioration is observed in a high-rate portion of Soccer, this is considered to be because of an absolute limit occurring on the PSNR at the time of enlargement due to an image reduction. FIG. 6 is a table showing the BD-rate and the relative coding and decoding time. A reduction in the coding volume of 32% and 23% was realized for Jets and Soccer, respectively. In addition, the coding time was reduced by 7 to 11%. The change in the decoding time was within about plus or minus 2%. These results indicate that there are cases where the sum of reduction amounts of prediction error is larger than the increase in the coding volume of coded data due to adding the sprite image.

As described above, the coding device 100 of the present embodiment generates an initial sprite image that is larger than each frame to be coded, and the initial sprite image is transformed to the same size as the frame to be coded. For this reason, the advantages of using the sprite image can also be obtained in a coding technique in which the number of pixels of a reference image is required to be the same as the number of pixels of an image to be coded. As a result, coding efficiency can be improved.

Although the embodiment of this invention has been described above in detail with reference to the drawings, the specific configuration is not limited to this embodiment, and also encompasses design or the like made within the scope that does not deviate from the gist of this invention.

### INDUSTRIAL APPLICABILITY

The present invention is applicable to techniques for coding images.

### REFERENCE SIGNS LIST

100 Coding device
10 Sprite generation unit
20 Resizing unit
30 Coding unit

1. A video encoding method comprising:
a provisional image generation step of generating one provisional image from a plurality of frames to be coded;
a transformation step of transforming the generated provisional image to a transformed image having the same number of pixels as that of each of the plurality of frames to be coded; and
a prediction image generation step of generating a prediction image for each of the frames to be coded, using the transformed image as a reference image.

2. The video coding method according to claim 1,
wherein in the prediction image generation step, a reference region corresponding to a region to be coded in the reference image and having a different number of pixels from the number of pixels of the region to be coded is specified using a relationship between the frames to be coded used when generating the provisional image.

3. The video coding method according to claim 1,
wherein the plurality of frames to be coded have the same number of pixels, and in the transformation step, the provisional image is transformed such that the number of pixels of each of the frames to be coded matches the number of pixels of the provisional image.

4. The video coding method according to claim 1,
wherein in the transformation step, rotation or shearing processing is further executed for the provisional image.

5. A video coding device comprising:
a processor; and
a storage medium having computer program instructions stored thereon, when executed by the processor, perform to:
generating one provisional image from a plurality of frames to be coded;
transforming the generated provisional image to a transformed image having the same number of pixels as that of each of the plurality of frames to be coded; and
generating a prediction image for each of the frames to be coded, using the transformed image as a reference image.

6. A non-transitory computer-readable medium having computer-executable instructions that, upon execution of the instructions by a processor of a computer, cause the computer to function as the video coding method of claim 1.
